(19) United States
(12) Patent Application Publication
(10) Pub. No.: US 2007/0246611 A1
(43) Pub. Date: Oct. 25, 2007

(54) Triboelectric treatment of wing and blade surfaces to reduce wake and BVI/HSS noise

(76) Inventor: Anadish Kumar Pal, Delhi (IN)

Correspondence Address: ANADISH KUMAR PAL, 194 VAISHALI, PITAMPURA, DELHI, 110088, omitted

(21) Appl. No.: 11/509,782

(22) Filed: Aug. 25, 2006

(30) Foreign Application Priority Data
Apr. 19, 2006 (IN) 1016/DEL/2006

(51) Int. Cl. B64C 3/14

(52) U.S. Cl. 244/35 R

(57) ABSTRACT

Triboelectric treatment of or addition to a wing tip and an airfoil upper and lower surfaces is selectively done to electrostatically mutually charge the wing tip and the airfoil upper and lower surfaces with the atmospheric air frictionally coming in contact, in order to reduce trailing-edge vorticity and to promote interlayer mixing in the downwash. Electrostatic forces impede air rollup around the wing tip by first pulling the rolling up air from the airfoil lower surface to the wing tip side face, holding, charging and then repelling the rolling up air to the airfoil upper surface. Triboelectric layers with opposite charges, stacked chord-wise or thickness-wise, form flat and rounded wing tips for vorticity and BVI-noise reduction. For similar effects, opposite triboelectric layers, stacked span-wise, form a rounded wing tip. Lining of thick trailing edge of an airfoil is done with a triboelectric beading to reduce trailing-edge vorticity and form drag.

### CROSS-REFERENCE TO RELATED APPLICATIONS

Foreign application priority claimed from Indian Patent Application No. 1016/DEL/2006 of Apr. 19, 2006, entitled, ‘Triboelectric treatment of wing and blade surfaces to reduce wake and BVI/HSS noise.’

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to reduction of aircraft wing wake and rotorcraft blade-vortex-interference and high-speed separation noise.

Since the 1970s, a lot or technological research has gone into the study and regulation of aircraft wing tip rollup and vortices. To achieve this, mainly wing tip shape is modified with the addition of turbines and air jet devices. Although, the effectiveness of many devices has made the aviation industry adopt the inventions for reducing aircraft wake and rotorcraft BVI noise. However, these devices mean major modifications to the tip shape or adding a lot of complexity to the wing tip structure.

Similarly, the trailing edge turbulence not only adds to HSS noise, but also imposes an energy penalty. There are electronic methods to induce electrostatic charge on the upper and lower surfaces of an airfoil to reduce trailing edge turbulence, but these methods need an outside HV generator with the associated problems of an accidental electrical spark generation. In some airfoils, it is not possible to reduce the thickness of the trailing edge beyond a point due to structural and safety reasons, like, for example, in the blades of a ceiling fan. Here again a method is required to reduce the trailing edge vorticity to increase the mechanical efficiency of the fan.

### BRIEF SUMMARY OF THE INVENTION

Consequent to the present level of prior art discussed hereinabove, there is a need for devices and methods which can offer simple, low risk, moderate return solutions to the above-discussed problems. Selective use of triboelectric materials and/or coatings on the wing surfaces is made to inventively charge the air rubbing against fast moving wing surfaces. Air is considered to be triboelectrically neutral, however, the presence of suspended particles help in imparting a static charge on it, when it rubs against various triboelectric materials. Similarly, triboelectric materials also get electrostatically charged as a result of air drag. An electrostatically charged triboelectric surface on the wing first attracts air and as soon as the air receives the charge it is repulsed. This charging process is employed to momentarily decelerate air near the wing tip to delay vortex rollup. This charging mechanism is employed in this invention to create airfoil surfaces like the trailing edge, where it is not possible to have a sharp trailing edge due to some constraint.

The present invention in various embodiments endeavors to approach the problems present in prior art in following manner:

In one embodiment of the present invention, the airfoil tip side face has a triboelectric property opposed to that of the rest of the airfoil surface, in order to decelerate the start of vortex rollup.

In the second embodiment of the present invention, the airfoil tip side face has chord-wise or thickness-wise stacked layers of alternately positioned positive and negative triboelectric materials, in order to impede the inception of vortex rollup.

In an alternate form of the present invention, the airfoil with a rounded tip has span-wise stacked layers of alternately positioned positive and negative triboelectric materials to put resistance to the start of vortex rollup.

In another form of the present invention, the lower and upper airfoil surfaces have chord-wise triboelectric stripes adjacent to the airfoil tip. The two triboelectric stripes are made of materials respectively having opposite triboelectric charging properties, and the tip side face has a coat or is composed of a material with neutral or near-neutral triboelectric charging properties.

In yet another form of the present invention, the airfoil tip side face has an attachment made of a material of triboelectric charging property opposed to that of the rest of the airfoil surface, in order to decelerate the rollup.

In a further form of the present invention, the airfoil upper and lower surfaces near the trailing edge are coated with materials respectively having opposite triboelectric charging properties.

In still another form of the present invention, the airfoil upper and lower surfaces are coated with materials respectively having opposite triboelectric charging properties, and the tip side face has a coat or is composed of a material with neutral or near-neutral triboelectric charging properties

In an additional form of the present invention, one of airfoil upper and lower surfaces is coated with a triboelectric material and the other surface is formed by the external composing material of the airfoil. The upper and lower surfaces have opposite triboelectric charging properties, and the tip side face has a coat or is composed of a material with neutral or near-neutral triboelectric charging properties

In an even further embodiment of the present invention, there is a strip or a strip coating just adjacent to the trailing edge, either on the upper or the lower airfoil surface of the airfoil. The strip or strip coating is composed of a material having triboelectric charging properties opposite to the triboelectric charging properties of the exterior surface of the airfoil.

A variant of the present invention is an airfoil with a thick trailing edge with a triboelectric beading which acts as an electrostatically blown trailing edge sharpener.

To assist in the understanding of the present invention recourse is taken to making use of drawings depicting the various functional and constructional aspects of the present invention in conjunction with the section of detailed description of the preferred embodiment.

### BRIEF DESCRIPTION OF THE SEVERAL VIEWS OF THE DRAWINGS

Accompanying drawings on 3 sheets are 7 in number. All the drawings are grid overlaid to bring out the airfoil shape and added triboelectric elements are stippled for easy identification. The basic airfoil section used throughout in the drawings is NACA 0012 with a rounded wing tip.

FIG. 1 is schematically diagrammatic tip-end partial side view of the wing with a rounded wing tip having a triboelectric coating or property.

FIG. 2 is schematically diagrammatic tip-end partial side view of the wing with a rounded wing tip and triboelectric chord-wise airfoil surface/surfaces.

FIG. 3 is schematically diagrammatic tip-end partial side view of the wing with a rounded wing tip and triboelectric trailing-edge surface/surfaces.

FIG. 4 is schematically diagrammatic tip-end partial side view of the wing with a rounded wing tip and a thick trailing edge with triboelectric coating or property.

FIG. 5 is schematically diagrammatic tip-end partial side view of the wing with a rounded wing tip having chord-wise stacked layers of alternately positioned positive and negative triboelectric materials.

FIG. 6 is schematically diagrammatic tip-end partial side view of the wing with a rounded wing tip having chord-wise stacked layers of alternately positioned positive and negative triboelectric materials.

FIG. 7 is schematically diagrammatic tip-end partial side view of the wing with a rounded wing tip having span-wise stacked and contoured layers of alternately positioned positive and negative triboelectric materials.

### DETAILED DESCRIPTION OF THE INVENTION

Triboelectric charging of airflow around aircraft wings and rotorcraft blades has the major advantage of being safe compared to electrical HV sources. Other HV sources cannot be implemented on open surfaces without ruling out electrical flashes which may lead to hazardous situations. Experiments were conducted using a three-rotor configuration with a total sweep of 1.5 meters and a maximum tip speed of approximately 0.1 Mach. The straight rotor blades had a chord length of 54 mm and they were of uniform cross section. The airfoil section somewhat resembled NACA 0016. The airfoil sections were constructed by uniformly rolling a 2 mm thick aluminum sheet to a diameter of 3.8 meters. Thereafter, straight strips were cut and two symmetrical halves for each rotor blade airfoil were profiled with the use of hand press and hand tools; each pair of symmetrical halves for each rotor blade was joined by argon welding to get a completed rotor. Hand filing was employed to finish the airfoil profile to a near approximation. The rotor blade tips were sealed using an epoxy sealant. The fixing ends of the rotor blades were joined to sheet metal clamps which connected the rotor blades to the induction motor which provided rotation. PVC electrical self-adhesive tape of 125 micron thickness, mica pieces of 200 micron thickness and nearly 1 mm thick layers of RTV silicone adhesive sealant (GE Bayer™, IS 8002—white) were employed to generate the initial test conditions. Human observers were asked to judge the changes in blade slap or BVI noise.

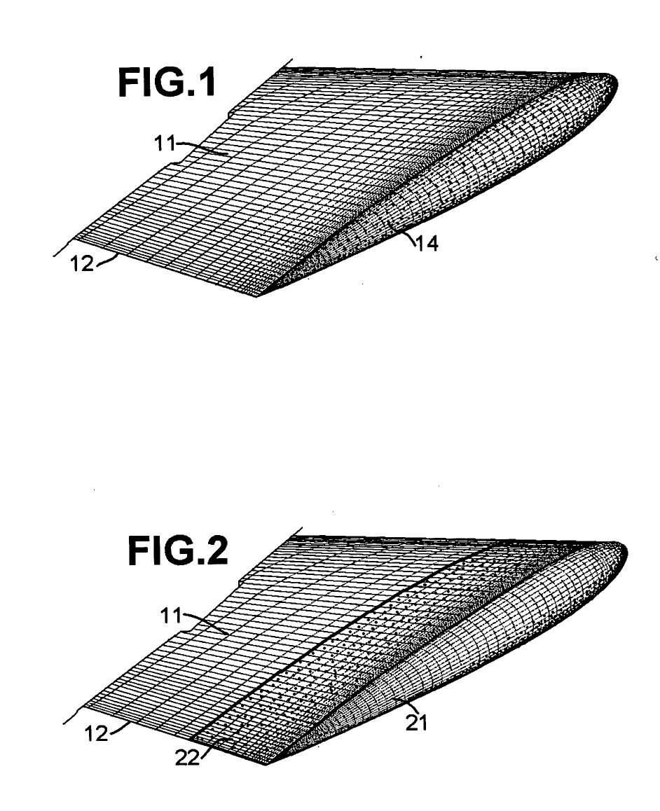

FIG. 1 through FIG. 7, the same airfoil section (NACA 0012) for various wing configurations is shown with uniform identifiers for airfoil upper surface 11 and trailing edge 12; however, the leading edge and the lower surface have not been marked in any of the figures.

In FIG. 1, airfoil tip side face 14 has a triboelectric property opposed to that of the rest of the airfoil surface consisting of upper surface 11, lower surface and trailing edge 12, in order to decelerate the start of vortex rollup. It is important that out of airfoil tip side face 14 or the rest of the airfoil surface, one has to be constructed of a dielectric material with triboelectric properties. Otherwise a potential difference cannot be maintained for the functioning of described embodiment the present invention.

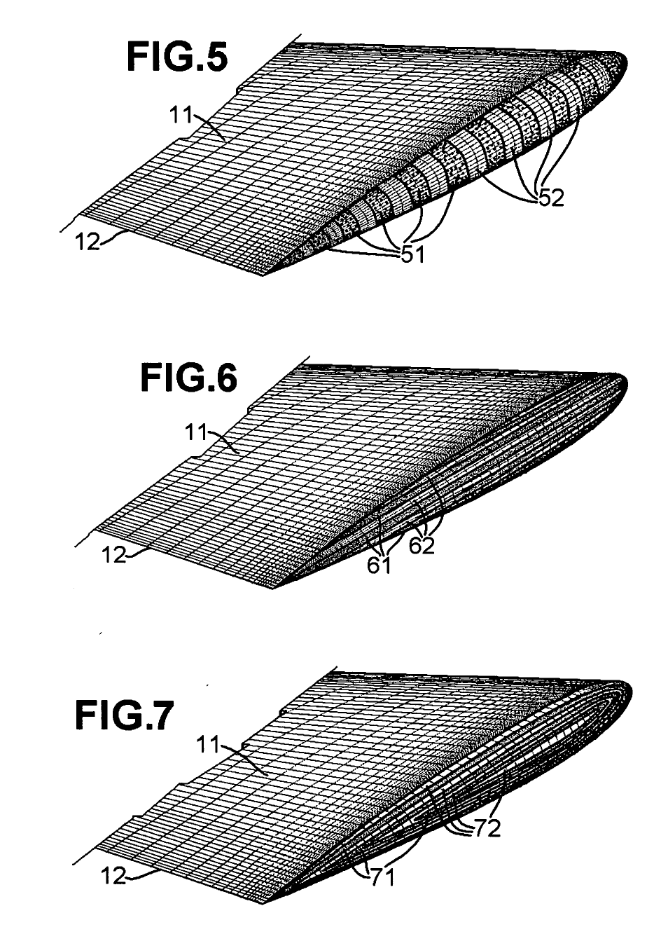

In FIG. 5, the airfoil tip side face has chord-wise stacked thickness-wise layers 51, 52 of alternately positioned positive and negative triboelectric materials, whereas the rest of the airfoil surface has triboelectrically near-neutral properties, in order to impede the inception of vortex rollup. In this embodiment of the present invention, out of the main airfoil construction material and the two materials employed for chord-wise stacked thickness-wise layers 51, 52, at least two have to be dielectric.

In FIG. 6, the airfoil tip side face has thickness-wise stacked chord-wise layers 61, 62 of alternately positioned positive and negative triboelectric materials, whereas the rest of the airfoil surface has triboelectrically near-neutral properties, in order to impede the inception of vortex rollup. In this embodiment of the present invention, out of the main airfoil construction material and the two materials employed for thickness-wise stacked chord-wise layers 61, 62, at least two have to be dielectric.

In an alternate form of the present invention herein described with the help of FIG. 7, the airfoil with a rounded tip has span-wise stacked tip-face-plane-wise layers 71, 72 of alternately positioned positive and negative triboelectric materials, whereas the rest of the airfoil surface has triboelectrically near-neutral properties, to put resistance to the start of vortex rollup. In this version too, out of the main airfoil construction material and the two materials employed for span-wise stacked tip-face-plane-wise layers 71, 72, at least two have to be dielectric.

In FIG. 2 the lower and upper airfoil surfaces have chord-wise triboelectric stripes (airfoil upper surface stripe 22) adjacent to the airfoil tip. The two triboelectric stripes are made of materials or coatings respectively having opposite triboelectric charging properties, and airfoil tip side face 21 has a coat or is composed of a material with neutral or near-neutral triboelectric charging properties.

In another implementation of the present invention, airfoil tip side face 14 in FIG. 1 can be in the form of an attachment made of a material of triboelectric charging property opposed to that of the rest of the airfoil surface, in order to decelerate the rollup.

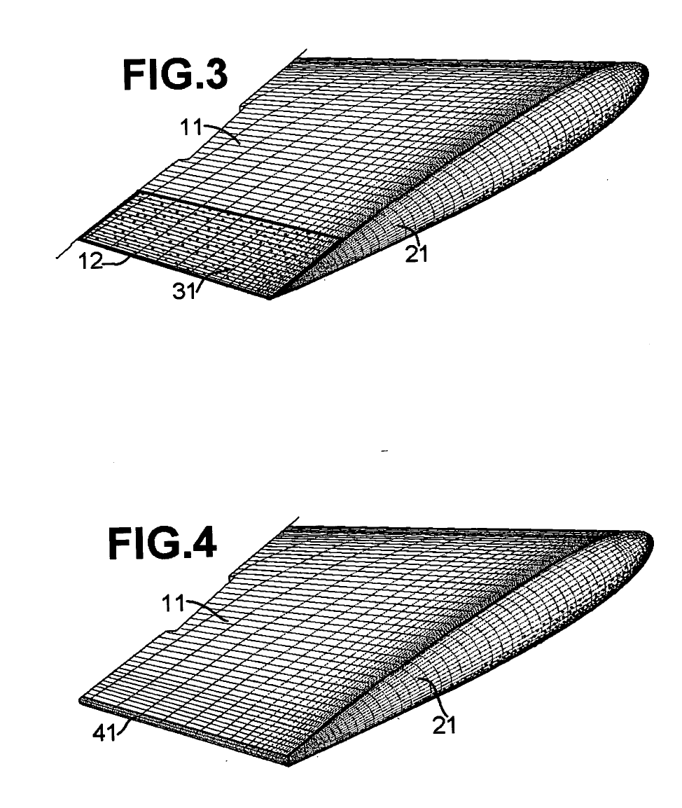

A further form of the present invention shown in FIG. 3, the airfoil upper and lower surfaces near the trailing edge are coated with materials respectively having opposite triboelectric charging properties (airfoil upper surface 11 is shown with trailing edge triboelectric coat 31).

With reference to FIG. 1, a form of the present invention is explained, where the airfoil upper and lower surfaces are coated with materials respectively having opposite triboelectric charging properties, and tip side face 21 has a coat or is composed of a material with neutral or near-neutral triboelectric charging properties. This embodiment of the present invention is especially useful in damping HSS noise together with delay in initial vortex rollup. All the following embodiments of the present invention are useful for the reduction of HSS noise together with reduced downwash vorticity due to a greater mixing in the boundary layers of the downwash due to opposite tribologically generated electrostatic charge.

With reference to FIG. 1, another form of the present invention can be explained where one of airfoil upper and lower surfaces is coated with or has a layer of a triboelectric material and the other surface is formed by the external composing material of the airfoil. Similarly, both the airfoil surfaces can have coatings or layers of two different tribolelectric materials. As a result, the upper and lower surfaces have opposite triboelectric charging properties, and tip side face 14 has a coat or is composed of a material with neutral or near-neutral triboelectric charging properties. However, irrespective of the composition of the tip side face, the opposite tribolelectric charging properties of the upper and lower airfoil surfaces are sufficient for a limited implementation of the present invention.

In an even further embodiment of the present invention, there is a strip or a strip coating just adjacent to the trailing edge, either on the upper or the lower airfoil surface of the airfoil (trailing edge triboelectric coat 31, FIG. 3). The strip or strip coating is composed of a material having triboelectric charging properties opposite to the triboelectric charging properties of the rest of the exterior surface of the airfoil.

In FIG. 4, a thick trailing edge is shown with trailing edge beading 41 with triboelectric property which acts as an electrostatically blown trailing edge sharpener. But for this effect to take place the rest of the airfoil surfaces have to have tribological properties opposed to that of trailing edge beading 41. It is possible to implement this embodiment of the present invention in conjunction with trailing edge triboelectric coat 31, FIG. 3 on one side or both sides of the airfoil.

A general functional description is hereby provided to the present invention which employs triboelectric material treatment to the surfaces of an airfoil to mitigate HSS and BVI noise and to reduce form drag by decreasing overall trailing edge vorticity. Translatory movement through the air of the airfoil at an angle of attack produces a positive pressure at lower surface and a negative pressure at the upper surface. The thrust on the air at the lower surface produces a rather uniform downward motion in the air coming in contact with the lower surface. The vacuum created in the air on top of the upper surface, forces air from all around to occupy the empty space; this air movement is much less uniform and follows the upper surface mainly due to Coanda effect to form the downwash behind the trailing edge. But due to the inherent difference in air molecular movements in the air from the lower surface and from the upper surface, the downwash has two layers and, as the boundary condition molecular movements are slow, the wing tip vortices take more time to diffuse. When the airfoil upper and lower surfaces are coated or made with materials with opposite triboelectric properties, the two layers in the downwash have a faster molecular interflow and the downwash has less amount of small turbulence and a faster diffusion. Similarly, an addition of triboelectric wing tip to an airfoil surface which largely has a triboelectrically neutral or opposite properties, slows down the wing tip vortex rollup process by first attracting the rollup air.

What is claimed is:

1. A wing with at least one airfoil, comprising:
the upper and lower surfaces of said airfoil having respective coatings or layers with materials having opposite triboelectric properties; and
out of said upper and lower surfaces at least one being dielectric.

2. A wing with at least one airfoil, comprising:
a flat or rounded wing tip side face of said wing with triboelectric property or properties different from those of the rest of the surfaces of said wing, which are proximate to said wing tip side face; and
out of said wing tip side face and said rest of said surfaces of said wing, either all or all save one being dielectric.

3. A wing of claim 2, comprising:
said flat or rounded wing tip side face of said wing having chord-wise or thickness-wise stacked correspondingly thickness-wise or chord-wise layers of alternately positioned positive and negative triboelectric materials;
the rest of the surface material of said wing having a neutral or near-neutral triboelectric property or properties; and
out of said flat or rounded wing tip side face of said wing having chord-wise or thickness-wise stacked correspondingly thickness-wise or chord-wise layers of alternately positioned positive and negative triboelectric materials, and said rest of the surface material of said wing, at least any two being dielectric.

4. A wing of claim 2, comprising:
said rounded wing tip side face of said wing having span-wise stacked, tip-face-plane-wise layers of alternately positioned positive and negative triboelectric materials,
the rest of the surface material of said wing having a neutral or near-neutral triboelectric property or properties; and
out of said rounded wing tip side face of said wing having said span-wise stacked, tip-face-plane-wise layers of alternately positioned positive and negative triboelectric materials, and said rest of the surface material of said wing, at least any two being dielectric.

5. A wing of claim 2, comprising:
said flat or rounded wing tip side face of said wing with a coat or composed of a material with a neutral or near-neutral triboelectric property;
the lower and upper wing surfaces with two chord-wise triboelectric stripes, one said chord-wise triboelectric stripes on either said wing surfaces, adjacent to said flat or rounded wing tip side face;
said chord-wise triboelectric stripes made of materials having opposite triboelectric properties; and
out of said flat or rounded wing tip side face, said two chord-wise triboelectric stripes and the lower and upper wing surfaces excluded by said two chord-wise stripes, at least any four being dielectric.

6. A wing of claim 2, comprising:
said flat or rounded wing tip side face of said wing with a an attachment made of a material with triboelectric property opposed to that of the rest of the surfaces of said wing.

7. A wing of claim 2, comprising:
the upper and lower surfaces of said airfoil having respective coatings near the trailing edge of said airfoil with materials having opposite triboelectric properties; and
out of said upper and lower surfaces left from said respective coatings and said respecting coatings, at least any two being dielectric.

8. A wing of claim 2, comprising:
the upper and lower surfaces of said airfoil having respective coatings near the trailing edge of said airfoil with materials having opposite triboelectric properties;
said respective coatings beginning from immediately adjacent to the wing tip of said wing and extending span-wise partially or fully;
said flat or rounded wing tip side face of said wing with a coat or composed of a material with a neutral or near-neutral triboelectric property; and
out of said upper and lower surfaces left from said respective coatings, said respecting coatings and said flat or rounded wing tip side face, at least any three being dielectric.

9. A wing of claim 2, comprising:
either the upper and lower surface of said airfoil having coating either near the trailing edge of said airfoil or on the whole surface of said airfoil; with a material having triboelectric property;
said coating beginning from immediately adjacent to the wing tip of said wing and extending partially or fully span-wise of said wing;
the other surface of said airfoil, not having said coat, having an inherent triboelectric property which is opposite to the triboelectric property of said coating;
side flat or rounded wing tip side face of said wing with a coat or composed of a material with a neutral or near-neutral triboelectric property; and
out of said coating, said flat or rounded wing tip side face of said wing with a coat or composed of a material with a neutral or near-neutral triboelectric property and said other surface of said airfoil, not having said coat, at least any two being dielectric.

10. A wing of claim 2, comprising:
either the upper and lower surface of said airfoil having a strip coating near the trailing edge of said airfoil, with a material having triboelectric property;
said coating beginning from immediately adjacent to said flat or rounded wing tip side face of said wing and extending span-wise partially or fully;
the other surface of said airfoil, not having said coat, having an inherent triboelectric property which is opposite to the triboelectric property of said strip coating; and
out of said strip coating and said other surface of said airfoil, not having said coat, any one being dielectric.

11. A wing with at least one airfoil, comprising:
a thick trailing edge lined with a beading with triboelectric property;
said beading having a generally semi-circular or triangular cross section;
the rest of the surfaces of said airfoil having triboelectric properties opposed to said triboelectric property of said beading; and
out of said wing tip side face, said beading and said rest of said surfaces of said wing, either all or all save one being dielectric.

12. A wing of claim 11, comprising:
a thick trailing edge lined with a beading with triboelectric property;
said beading having a generally semi-circular or triangular cross section;
the rest of the surfaces of said airfoil having triboelectric properties opposed to said triboelectric property of said beading;
a flat or rounded wing tip side face of said wing with triboelectric property or properties different from those of the rest of the surfaces of said wing, which are proximate to said wing tip side face; and
out of said wing tip side face, said beading and said rest of said surfaces of said wing, either all or all save one being dielectric.

13. A wing of claim 12, comprising:
said flat or rounded wing tip side face of said wing having chord-wise or thickness-wise stacked correspondingly thickness-wise or chord-wise layers of alternately positioned positive and negative triboelectric materials;
the rest of the surface material of said wing having a neutral or near-neutral triboelectric property or properties; and
out of said flat or rounded wing tip side face of said wing having chord-wise or thickness-wise stacked correspondingly thickness-wise or chord-wise layers of alternately positioned positive and negative triboelectric materials, and said rest of the surface material of said wing, at least any two being dielectric.

14. A wing of claim 12, comprising:
said rounded wing tip side face of said wing having span-wise stacked, tip-face-plane-wise layers of alternately positioned positive and negative triboelectric materials,
the rest of the surface material of said wing having a neutral or near-neutral triboelectric property or properties; and
out of said rounded wing tip side face of said wing having said span-wise stacked, tip-face-plane-wise layers of alternately positioned positive and negative triboelectric materials, and said rest of the surface material of said wing, at least any two being dielectric.

15. A wing of claim 12, comprising:
said flat or rounded wing tip side face of said wing with a coat or composed of a material with a neutral or near-neutral triboelectric property;
the lower and upper wing surfaces with two chord-wise triboelectric stripes, one said chord-wise triboelectric stripes on either said wing surfaces, adjacent to said flat or rounded wing tip side face;
said chord-wise triboelectric stripes made of materials having opposite triboelectric properties; and
out of said flat or rounded wing tip side face, said two chord-wise triboelectric stripes and the lower and upper wing surfaces excluded by said two chord-wise stripes, at least any four being dielectric.

16. A wing of claim 12, comprising:
said flat or rounded wing tip side face of said wing with an attachment made of a material with triboelectric property opposed to that of the rest of the surfaces of said wing.

17. A wing of claim 12, comprising:
the upper and lower surfaces of said airfoil having respective coatings near the trailing edge of said airfoil with materials having opposite triboelectric properties; and
out of said upper and lower surfaces left from said respective coatings and said respecting coatings, at least any two being dielectric.

18. A wing of claim 12, comprising:
the upper and lower surfaces of said airfoil having respective coatings near the trailing edge of said airfoil with materials having opposite triboelectric properties;
said respective coatings beginning from immediately adjacent to the wing tip of said wing and extending span-wise partially or fully;
said flat or rounded wing tip side face of said wing with a coat or composed of a material with a neutral or near-neutral triboelectric property; and
out of said upper and lower surfaces left from said respective coatings, said respecting coatings and said flat or rounded wing tip side face, at least any three being dielectric.

19. A wing of claim 12, comprising:
either the upper and lower surface of said airfoil having coating either near the trailing edge of said airfoil or on the whole surface of said airfoil, with a material having triboelectric property;
said coating beginning from immediately adjacent to the wing tip of said wing and extending partially or fully span-wise of said wing;
the other surface of said airfoil, not having said coat, having an inherent triboelectric property which is opposite to the triboelectric property of said coating;
said flat or rounded wing tip side face of said wing with a coat or composed of a material with a neutral or near-neutral triboelectric property; and
out of said coating, said flat or rounded wing tip side face of said wing with a coat or composed of a material with a neutral or near-neutral triboelectric property and said other surface of said airfoil, not having said coat, at least any two being dielectric.

20. A wing of claim 12, comprising:
either the upper and lower surface of said airfoil having a strip coating near the trailing edge of said airfoil, with a material having triboelectric property;
said coating beginning from immediately adjacent to said flat or rounded wing tip side face of said wing and extending span-wise partially or fully;
the other surface of said airfoil, not having said coat, having an inherent triboelectric property which is opposite to the triboelectric property of said strip coating; and
out of said strip coating and said other surface of said airfoil, not having said coat, any one being dielectric.
